(19) United States
(12) Patent Application Publication
(10) Pub. No.: US 2002/0024940 A1
(43) Pub. Date: Feb. 28, 2002

(54) Method and apparatus for a communication system having multiple service functionality

(76) Inventor: Scott R. Smith, Crystal Lake, IL (US)

Correspondence Address: Wallenstein & Wagner, Ltd., 311 S. Wacker Drive, 53rd Floor, Chicago, IL, 60606-6630, US

(21) Appl. No.: 09/877,733

(22) Filed: Jun. 8, 2001

Related U.S. Application Data
(60) Provisional application No. 60/210,209, filed on Jun. 8, 2000.

(51) Int. Cl. H04Q 7/00

(52) U.S. Cl. 370/329; 370/216

(57) ABSTRACT

The present invention provides a single electronic device that is capable of communicating within a wireless data network and at least one other communications network to effectively provide expanded coverage for data communications with the device. The wireless data network allows the device to access a second data network, preferably a land-line-based data network, that provides virtually unlimited connectivity to other networks, including other wireless networks. The present invention also includes a method of providing multiple network service through a single service provider. The single service provider acts as a reseller of other network services and provides a customer with a single source for billing purposes. The present invention further includes a method of notification through one of the other communications networks, such as a paging network, when a recipient of a data communication, such as an e-mail, is out of range of the data network.

### RELATED APPLICATIONS

This patent application claims the benefit of U.S. Provisional Patent application, entitled “Electronic Device Having Multiple Service Functionality,” serial No. 60/210,209, filed Jun. 8, 2000.

### TECHNICAL FIELD

The present invention generally relates to electronic devices having wireless data and communications capability, and more particularly to a PDA (Personal Digital Assistant) or other handheld computer or communications device having multiple service functionality through a single service provider re-seller.

### BACKGROUND OF THE INVENTION

The growth of the computer and communications industries has caused the development ofnew computer and communications devices having greater functionality and capability. In particular, with the recent growth of the wireless data communication industry, PDAs (Personal Digital Assistants), handheld computers, cellular telephones having data capability, and other such portable devices have become quite popular.

Traditional wireless communications networks, such as cellular and paging service networks, currently provide excellent geographical coverage because these technologies have undergone tremendous growth in the past. In that period of time, cellular and paging network infrastructure has increased to allow network coverage in major geographical market areas without reliance on satellite communications.

With the recent boom in the wireless data communications industry, traditional wireless communications networks have proven to be rather limiting. While land line data networks provide virtually unlimited network access and coverage, wireless data network access remains limited. Wireless data networks have recently shown some growth, but the geographical coverage of such networks is nowhere near the coverage offered by cellular and paging networks. This poses a problem for recently developed data communications devices, such as PDAs having wireless data capability, that strive to provide users portable access to data regardless of their location. This is particularly a problem with e-mail communications sent via a PDA wireless data network service to a recipient that is out of range of the network. Wireless access to a land line data network is essential for effective data communication with such devices.

It is therefore an object of the present invention to provide a single electronic device that is capable of communicating within a wireless data network and at least one other communications network to effectively provide expanded coverage for data communications.

It is also an object of the present invention to provide multiple network service for a single electronic device through a single service provider that is a reseller of the network services.

It is also an object of the present invention to provide a single billing statement to a customer from a single service provider for multiple network service access via a single electronic device.

It is a further object of the present invention to provide a device and method capable of notifying an “out-of-range” recipient of an e-mail via a data network by sending the recipient an e-mail notification via a paging network.

### SUMMARY OF THE INVENTION

The present invention provides a single electronic device that is capable of communicating within a wireless data network and at least one other communications network to effectively provide expanded coverage for data communications with the device. The wireless data network allows the device to access a second data network, preferably a land-line-based data network, that provides virtually unlimited connectivity to other networks, including other wireless networks. The present invention also includes a method of providing multiple network service through a single service provider. The single service provider acts as a reseller of other network services and provides a customer with a single source for billing purposes. The present invention further includes a method of notification through one of the other communications networks, such as a paging network, when a recipient of a data communication, such as an e-mail, is out of range of the data network.

Another embodiment of the present invention is directed to a communication system comprising a wireless device, a first wireless communication network and a second wireless communication network. The communication system further includes an indicator for indicating if a communication link has been established between the wireless device and the first wireless communication network wherein the second wireless communication network being responsive to the indicator for sending a notification to the wireless device upon a failure to establish the communication link.

### BRIEF DESCRIPTION OF THE DRAWING

FIG. 1 is a schematic diagram of a land line data network having a wireless data network co-located with the land line data network, thereby providing the wireless data network access to multiple service networks.

### DETAILED DESCRIPTION OF THE PREFERRED EMBODIMENTS

While the present invention will be described fully hereinafter with reference to the accompanying drawings, in which a particular embodiment is shown, it is to be understood at the outset that persons skilled in the art may modify the invention herein described while still achieving the desired result of this invention. Accordingly, the description which follows is to be understood as a broad informative disclosure directed to persons skilled in the appropriate arts and not as limitations of the present invention.

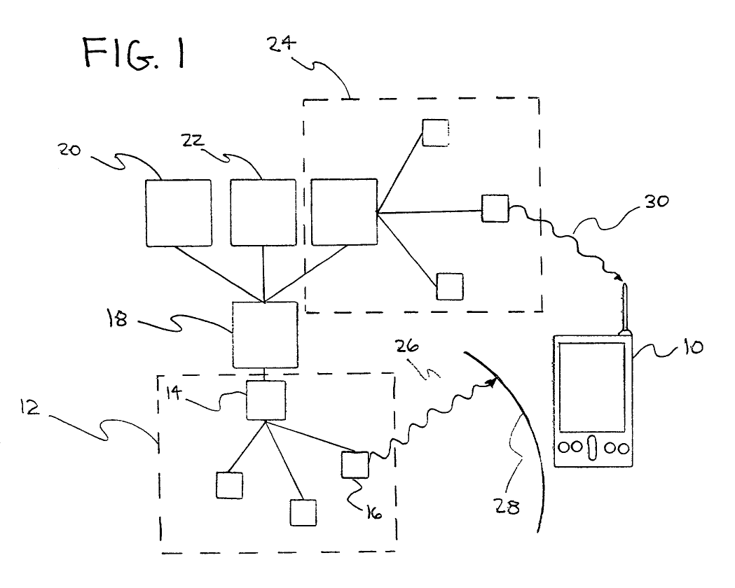

FIG. 1 shows a schematic diagram of a multiple network interaction with an electronic device 10 having wireless communication capability. Preferably, the electronic device 10 is a PDA-type device having wireless communication capability. As shown in FIG. 1, a wireless data network 12 comprises at least one server 14 and at least one base station 16 of a base station network (not shown) in communication with the server 14 that provides wireless communication with the device 10. The server 14 is in communication with a land-line based data network 18 and is preferably co-located at a central office, hub, data center, or other equivalent infrastructure site of the data network 18.

By way of example, the data network 18 provides connectivity to a plurality of other networks, such as a cellular network 20, World Wide Web 22, and a paging network 24. However, the data network 16 essentially provides connectivity to any type of other network via a number of different network architectures, both land-line-based and wireless-based architectures. Such network architectures may include the PSTN (Public Switched Telephone Network), Community Access Television (CATV) network, the Integrated Services Digital Network (ISDN), the Internet, a local area network (LAN), a wide area network (WAN), any type of wireless communications network, or an asynchronous transfer mode (ATM) network. The data network 18 may be of any type of network architecture, including wireless-based architectures, but preferably is a land-line-based network.

According to the present invention, the electronic device 10 is capable of communicating within a multiple number of wireless and land-line-based networks. Preferably, the electronic device 10 is capable of dual communication within the wireless data network 12 and the paging network 24 via the data network 18, as shown in FIG. 1. The electronic device 10 utilizes an ESN (electronic serial number) for each of the wireless networks accessible by the device 10. Each ESN provides identification of the device 10 within the appropriate network.

According to one embodiment, when a data communication 26, such as an e-mail, is sent to the electronic device 10 while the electronic device 10 is out of a maximum range 28 of the wireless data network 12, an indicator indicates if a communication link has been established. In response to a failure to establish the communication link, the second wireless communication network sends a notification to the wireless device 10. Alternatively, upon a failure to establish a communication link, the server 14 of the data network 12 accesses the paging network 24 via the data network 18 and sends a page 30 to the device 10. The page 30 is a data communication in the form of a notification that an e-mail has been received and sent to the device 10. The notification can also be a message, a flag, a light, etc., notifying the user. When a user receives the notification, he or she can then access the e-mail communication via an alternate network connection to the server 14 or wait until the device 10 is within range 28. If the electronic device 10 was initially within the range 28 of the wireless data network 12, the device 10 would automatically receive the e-mail communication.

The present invention also provides a method of providing multiple network services through a single service provider of the wireless data network 12. The single service provider acts as a reseller of other network services, such as paging service on the paging network 24, and provides a customer with a single source for billing purposes. The single service provider can provide connectivity to a wide range of other networks. Furthermore, the device 10 can be designed to communicate with numerous different wireless network services to further enhance the connectivity of the device 10.

It is to be understood that the schematic of FIG. 1 is a general representation depicting network interfacing and connectivity and may include the use of various hardware components well known in the art. Furthermore, many of the interfacing and connectivity contemplated by the present invention may also be achieved through software programs alone or a combination of both hardware and software (i.e., firmware) without departing from the present invention.

What is claimed is:

1. A communication system comprising:
a wireless device;
a first wireless communication network;
a second wireless communication network; and,
an indicator for indicating if a communication link has been established between the wireless device and the first wireless communication network, the second wireless communication network responsive to the indicator for sending a notification to the wireless device upon a failure to establish the communication link.

2. The communication system of claim 1 wherein the indicator is a flag.

3. The communication system of claim 1 wherein the wireless device is a personal digital assistant.

4. The communication system of claim 1 wherein the first wireless communication network is capable of wireless voice communication.

5. The communication system of claim 1 wherein the first wireless communication network is capable of wireless voice communication.

6. The communication system of claim 5 wherein the first wireless communication network is capable of wireless data communication.

7. The communication system of claim 1 wherein the notification is a message.

8. The communication system of claim 1 further comprising:
a land line based data network operably connected to the first wireless communication network and the second wireless communication network.

9. A method for wireless communication comprising the steps of:
providing a wireless device;
providing a first wireless communication network;
providing a second wireless communication network;
indicating if a communication link has been established between the wireless device and the first wireless communication network; and,
sending a notification to the wireless device upon a failure to establish the communication link.
